(19) United States
(12) Patent Application Publication
(10) Pub. No.: US 2026/0268930 A1
(43) Pub. Date: Sep. 10, 2026

(54) GIMBAL CIRCUIT LIMITER

(71) Applicant: Seagate Technology LLC, Fremont, CA (US)

(72) Inventors: Jackson William Brandts, Watertown, MN (US); Razman Zambri, Eden Prairie, MN (US)

(21) Appl. No.: 19/073,286

(22) Filed: Mar. 7, 2025

(51) Int. Cl. G11B 5/48

(52) U.S. Cl. CPC G11B 5/4826; G11B 5/4833; G11B 5/4853

(57) ABSTRACT

A disk drive assembly includes a load beam having a longitudinal centerline and a flexure attached to the load beam. The flexure includes deflectable tongue and a ring. The deflectable tongue includes a pad configured for mounting a slider having a trailing edge. The ring surrounds a trailing edge portion of the tongue and includes a catch. The tongue includes a plurality of limiters that are disposed symmetrically about the longitudinal centerline, that are bent from a plane of the pad, and that extend away from the slider. The plurality of limiters are configured to contact the catch to limit deflection of the slider. A method of limiting deflection of an air bearing slider in a z-direction is also described.

### BACKGROUND

Hard disk drives utilize one or more magnetic recording heads fabricated on sliders to read and write data on magnetic storage media. Typically, a slider is mounted on a trace gimbal assembly (TGA); the combination of the slider and TGA is collectively known as a head gimbal assembly (HGA). In the HGA, the slider is suspended on a thin cushion of air or gas just above the surface of the magnetic storage media.

### SUMMARY

In one embodiment, a disk drive assembly comprises a load beam having a longitudinal centerline and a flexure attached to the load beam. The flexure comprises deflectable tongue and a ring. The deflectable tongue comprises a pad configured for mounting a slider having a trailing edge. The ring surrounds a trailing edge portion of the tongue and comprises a catch. The tongue comprises a plurality of limiters that are disposed symmetrically about the longitudinal centerline, that are bent from a plane of the pad, and that extend away from the slider. The plurality of limiters are configured to contact the catch to limit deflection of the slider.

In another embodiment, a method of limiting deflection of an air bearing slider in a z-direction is described. The method comprises obtaining the air bearing slider that is positioned on a longitudinal centerline of a load beam, wherein the slider is mounted to a pad of a deflectable tongue of a flexure attached to the load beam, wherein the tongue comprises a plurality of limiters that extend upward and are positioned transversely outward of rails of the load beam; and establishing physical contact between the plurality of limiters and a catch attached to a ring of the flexure.

This summary and the Abstract are provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1 is a schematic illustration of an exemplary data storage device.

FIG. 2 is a perspective view of an exemplary head gimbal assembly (HGA), in accordance with aspects of this disclosure.

FIG. 3 is a top view of the distal end of the exemplary HGA.

FIG. 4 is a perspective view of a portion of FIG. 3, with an upper plate of the load beam removed.

FIG. 5 is a side view of a portion of the exemplary HGA.

FIG. 6 is a bottom perspective view of the distal end of the exemplary HGA.

FIG. 7 is a bottom view of a portion of the components shown in FIG. 6, without the slider.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

### DETAILED DESCRIPTION OF ILLUSTRATIVE EMBODIMENTS

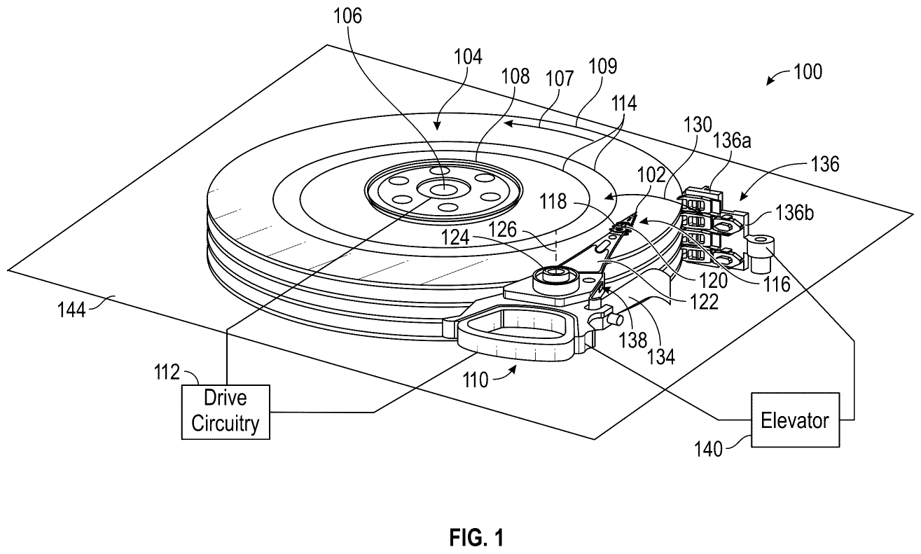

FIG. 1 shows an illustrative operating environment in which certain embodiments disclosed herein may be incorporated. The operating environment shown in FIG. 1 is for illustration purposes only. Embodiments of the present disclosure are not limited to any particular operating environment and can be practiced within any number of different types of operating environments.

It should be noted that the same reference numerals are used in different figures for the same or similar elements. All descriptions of an element also apply to all other versions of that element unless otherwise stated. It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

It will be understood that, when an element is referred to as being “connected,” “coupled,” or “attached” to another element, it can be directly connected, coupled or attached to the other element, or it can be indirectly connected, coupled, or attached to the other element where intervening or intermediate elements may be present. In contrast, if an element is referred to as being “directly connected,” “directly coupled” or “directly attached” to another element, there are no intervening elements present. Drawings illustrating direct connections, couplings or attachments between elements also include embodiments, in which the elements are indirectly connected, coupled or attached to each other.

FIG. 1 is a schematic illustration of a data storage device (DSD) 100 including data storage media 104, a slider 102 carrying heads for reading data from and/or writing data to the data storage media 104, and a split ramp 136 for supporting a suspension load beam 120 that supports the slider 102. In the embodiment shown in FIG. 1, the data storage media 104 are rotatable data storage disks stacked on spindle 106, with each disk 104 having opposing surfaces that serve as data storage surfaces. For read and write operations, a spindle motor rotates the media 104 as illustrated by arrow 107, and actuator mechanism 110 positions the slider 102 relative to data tracks 114 on the rotating media 104 between an inner diameter (ID) 108 and an outer diameter (OD) 109. Both the spindle motor and actuator mechanism 110 are connected to and operated through drive circuitry 112 (schematically shown). The actuator mechanism 110 may have a voice coil drive, for example.

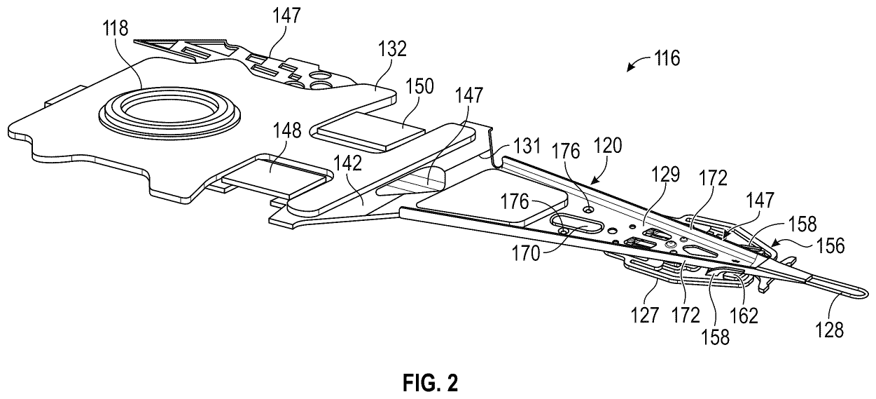

The actuator mechanism 110 is rotationally coupled to a frame or base deck 144 through a pivot shaft 124 to rotate actuator arm 122 about longitudinal axis 126 of shaft 124. As shown in FIG. 2, the head gimbal assembly (HGA) 116 has an attachment structure 118 on base plate 132 configured to connect to the actuator arm 122. Air bearing slider 102 is carried by load beam 120 and includes one or more transducer elements, such as read/write heads (not shown), coupled to head circuitry through flex circuit 134, shown in FIG. 1. The actuator mechanism 110 moves the slider 102 in a cross-track direction as illustrated by arrow 130. In an exemplary embodiment, slider 102 is aerodynamically designed to fly on an active air bearing (AAB) that is created adjacent to the disk surface during disk rotation.

In general, in order to prevent slider 102 from landing on disks 104 in a data storage device 100 when, for example, power is removed from the data storage device 100, and to prevent the slider 102 from colliding with outer edges of the disks 104 during load and unload operations, a head support ramp assembly 136 is provided adjacent to the OD 109 of the disks 104.

In the illustrated embodiments, the air bearing slider 102 for carrying the read/write heads is shown as attached to a bottom surface of the load beam 120. However, it is to be understood that an actuator arm can also carry a load beam that has a slider with read/write heads that face upward from the load beam, in a configuration that allows the heads to read and write data relative to a data surface of a disk 104 that is positioned above the load beam 120. In that case, it is to be understood that the teachings of an exemplary limiter assembly 156 can be inverted from the illustrated embodiments.

In an exemplary embodiment in which the number of sliders 102 is fewer than a number of data surfaces of media 104, actuator arm 122 may be moved in a z direction (along axis 126 of shaft 124) to different height positions under the motive of elevator 140, which is schematically shown in FIG. 1. Thus, a single HGA 116 can be moved to place its slider 102 in position to read and write data from any of the disks 104 of the stack of data storage disks. In general, any suitable driving mechanism may be used to move elevator 140 up and down. Exemplary drivers for Z direction motion of elevator 140 include a ball screw with an internal motor, a voice coil motor, an inchworm style brake crawler, a linear motor, a shape memory alloy based actuator, and a combination of the above.

When the read/write heads of a slider 102 are not actively in use for data transfer operations, the actuator mechanism 110 can be activated to rotate the actuator arm 122 in order to place the lift tab 128 of load beam 120 on head support ramp assembly 136. Head-support ramp assembly 136 in some embodiments is designed as a split ramp with a stationary portion 136a and moveable portion 136b. With lift tab 128 supported on the moveable ramp 136b, the paired actuator arm 122 and the moveable portion 136b can be moved in unison along axis 126 (such as vertically or in a z direction) by the operationally connected elevator 140. In some embodiments, an entire ramp 136 or a portion thereof can also be moved in the x-y plane off the disk stack, such as by retraction, flexing, or rotation, for example.

While the illustrated environment of FIG. 1 depicts a DSD with a rotary actuator mechanism 110, it is to be understood that the disclosed concepts can also be practiced in a DSD having a linear driver for the actuator arm, such as described in commonly owned U.S. Pat. No. 11,348,611 for “Zero Skew Elevator System,” and in commonly owned U.S. Pat. No. 11,361,787 for “Zero Skew Disk Drive with Dual Actuators,” and in commonly owned U.S. Pat. No. 11,430,472 for “Triple Magnet Linear Actuator Motor,” and in commonly owned U.S. Pat. No. 11,488,624 for “Ball Bearing Cartridge for Linear Actuator,” which are hereby incorporated by reference.

FIG. 2 is a perspective view of HGA 116, according to various aspects of this disclosure. HGA 116 includes a base plate 132, a load beam 120, a flexure 147 including a gimbal 127, and a slider 102 (not visible in FIG. 2). Baseplate 132 includes an attachment structure 118, such as a boss tower, that is configured to couple to actuator arm 122 of FIG. 1. In one example, attachment structure 118 is integrally formed with baseplate 132. Baseplate 132 and attachment structure 118 may each be made of a ferrite (e.g., stainless steel) or other suitable material (e.g., aluminum, engineered plastic, and the like).

In one example, load beam 120 includes a base portion 142, a hinge region 131 and a rigid region 129. Load beam 120 may be made of a ferrite (e.g., stainless steel) or other suitable material. Base portion 142 of load beam 120 is mechanically coupled to baseplate 132. In some examples, base portion 142 is coupled to baseplate 132 via welding (e.g., laser welding). Hinge region 131 (also referred to as a spring region) provides load beam 120 with a preload force that acts against the lift force action of slider 102 as slider 102 flies relative to the disk surface. The preload force urges slider 102 towards the surface of a magnetic media 104 during flight to maintain a desired fly height. In some examples, hinge region 131 is integrated with and contiguous with load beam 120 as a single part. In the example of FIG. 2, hinge region 131 is disposed between base portion 142 and rigid region 129. Rigid region 129 of load beam 120 extends from hinge region 131 to the tip of the HGA 116 to which the lift tab 128 is attached.

In an exemplary embodiment, rigid region 129 is bounded by rails 172; rails 172 are illustrated as on the top surface of load beam 120, although in other embodiments rails 172 may be present on the bottom surface of load beam 120. Rails 172 provide lateral and bending stiffening and increase torsion resistance to load beam 120. Rails 172 are typically present on ‘thin’ load beams 120 having a thickness of rigid region 129 that is less than 0.05 mm; load beams made from a thicker material may not include rails, as the material itself provides sufficient stiffness to beam 120. Rails 172 are often formed by folding or bending the material (e.g., stainless steel) that forms rigid region 129.

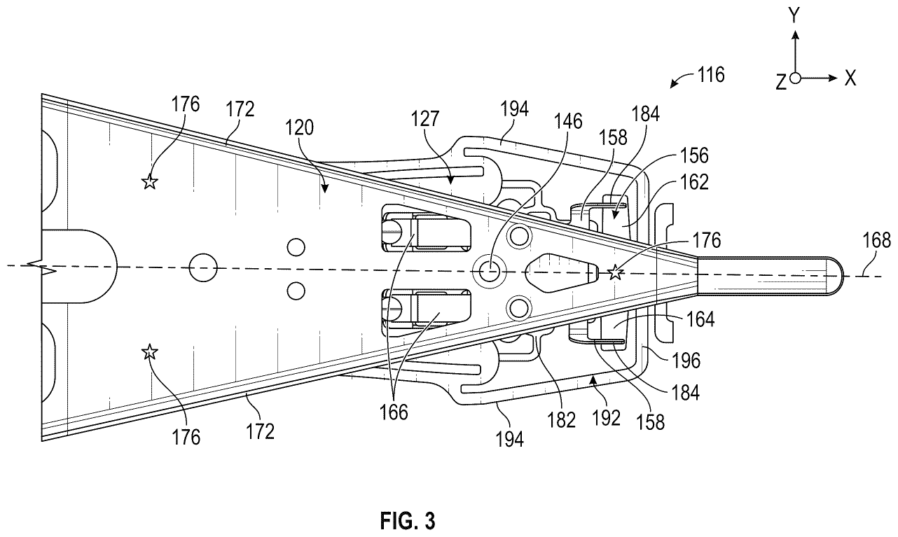

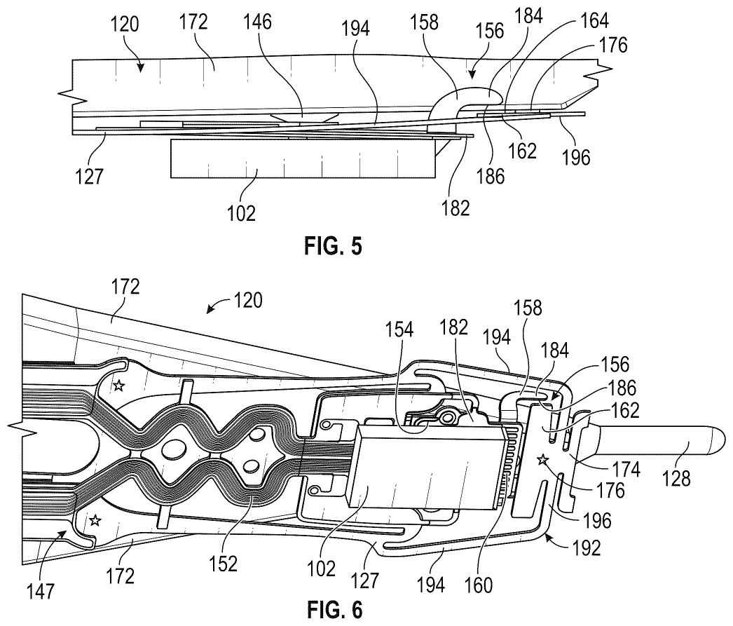

Flexure 147 is attached, such as by welding at weld locations 176 (see FIGS. 3, 6 and 7) to load beam 120. Flexure 147 includes gimbal 127, which has a tongue 182 partially surrounded by a ring 192. Ring 192 includes side struts 194 that meet at distal portion 196. Moreover, a central slider mounting region 154 of tongue 182 is pivotable about a slider dimple 146 on load beam 120 (see FIG. 5). Thus, gimbal 127 provides a moveable slider mounting pad 154 to which slider 102 is attached so that slider 102 can move in the pitch, roll, and yaw directions in response to variations while flying relative to a disk surface.

Examples of active components of HGA 116 include readers, writers, and heaters of the magnetic recording head of slider 102 and microactuators 148, 150 of flexure 147. Flexure 147 electrically couples slider 102 to drive circuitry 112 and flex circuit 134. In an exemplary embodiment, flexure 147 includes an electrical trace ribbon 152 that is configured to provide electrical signal pathways to and from active components of HGA 116. In some examples, flexure 147 includes a substrate or bottom layer of insulating material (e.g., polyimide, glass fiber epoxy laminate, PTFE or other suitable material), capped with a top layer of insulating material (e.g., polyimide, glass fiber epoxy laminate, PTFE or other suitable material) with a layer of semi-rigid conducting material (e.g., copper, aluminum, tin, stainless steel or an alloy) disposed between the top and the bottom insulating layers. Flexure 147 may, in some examples, be bonded along HGA 116. In reference to FIG. 2, flexure 147 runs along load beam 120 from the base portion 142 to rigid region 129 to electrically connect with the read/write head of the slider 102. Electrical trace ribbon 152 may include any number of conductors that may be electrically coupled to slider 102, one or more microactuators 148, 150, and/or other active components.

As shown in the example of FIG. 2, HGA 116 includes a pair of microactuators 148 and 150 coupled to the baseplate 132. While the voice coil motor of FIG. 1 rotates actuator mechanism 110 to provide relatively coarse positioning of sliders 102, microactuators 148 and 150 provide HGA 116 with relatively fine or precision positioning of slider 102 at the surface of magnetic media 104. In one example, microactuators 148 and 150 are piezoelectric microactuators, and in some examples may be made of lead zirconate titanate (PZT). Piezoelectric microactuators convert an electrical signal into controlled physical displacements. In an exemplary embodiment, microactuators 148, 150 expand and contract to move the slider 102 over a media surface. This movement can be used to provide a secondary, finer resolution level of tracking of slider 102, such as tracking of a slider 102 relative to data tracks 114 of FIG. 1, supplementing the tracking provided by voice coil drive motor and actuator mechanism 110. The additional resolution provided by microactuators 148, 150 may enable data tracks 114 on a media surface 104 to be closer to one another, thereby potentially increasing the areal density capability of a hard disk drive.

In an exemplary embodiment, HGA 116 includes microactuators 166 that are configured to provide additional fine resolution positioning of slider 102 over a media surface during the reading and writing of data tracks 114. Microactuators 166 may expand and contract to induce motion of slider 102 in the X-Y plane of FIG. 3. Such motion may provide fine positioning resolution of a magnetic recording head of slider 102 during reading and writing data tracks 114. In some examples, microactuators 166 may be used in conjunction with microactuators that are coupled to a baseplate of HGA 116, such as microactuators 148, 150 of FIG. 2.

In an exemplary embodiment, slider 102 is suspended in proximity to a media surface 104 and is supported by load beam 120. Load beam 120 exerts a force, known as the preload force, on slider 102 through rigid region 129 of load beam 120. The preload force urges slider 102 toward the media surface. An opposing force directed away from the media surface is exerted on slider 102 by a cushion of air, helium or other gas proximal to an outer surface of slider 102 that faces the media surface. This cushion of gas, known as an active air bearing (AAB), is produced from a dynamic flow of gas across a pattern of recessed sub-surfaces bound within the volume of slider 102 by the outer surface of slider 102 that faces the media surface. The force of the AAB on slider 102 in a direction facing away from the media surface is countered by the preload force exerted on slider 102 by load beam 120. These opposing forces maintain slider 102 at a passive fly height above the media surface as the media is rotating. The writers and readers (not shown) of a magnetic recording head of slider 102 protrude from the media facing surface of slider 102 toward the media surface with assistance from active heaters of the magnetic recording head. These protrusions are controlled to maintain slider 102 at a desired active fly height during read and write operations.

During a shock event, such as during shipping or if the disk drive is dropped, slider 102 can pull flexure 147 away from load beam 120 in the absence of a deflection limiting mechanism. The stress from the shock event could be high enough to distort flexure 147 and result in changes to the pitch and roll static angle of flexure 147. A deflection limiting mechanism prevents this from happening by ensuring that the deflection is not too large to cause the stress on flexure 147 to reach the yield point.

A deflection limiter is more effective when it is at or near the trailing edge side of the slider, rather than at the leading edge side of the slider. Limiters are used to mechanically prevent a slider 102 from flying too far away from the load beam 120 in the z direction. A known T-bar style limiter is shown in commonly owned U.S. Pat. No. 8,837,090 to Greminger for “Gimbal limiter for suspension with lift tab,” which is hereby incorporated by reference. However, the T-bar style limiter cannot be used in some gimbal designs because piezoelectric micro-actuators are in the locations typically used for the T-bar style limiter. Additional limiters are described in commonly owned U.S. Pat. No. 6,611,402 to Mangold for “Pitch-adjustable head suspension with end lift tab for dynamic load/unload” and U.S. Pat. No. 7,839,604 to Coffey for “Disk drive suspension assembly with integrated trailing edge shock protection for use with micro-actuator type head-gimbal assembly;” these patents are hereby incorporated by reference in their entireties.

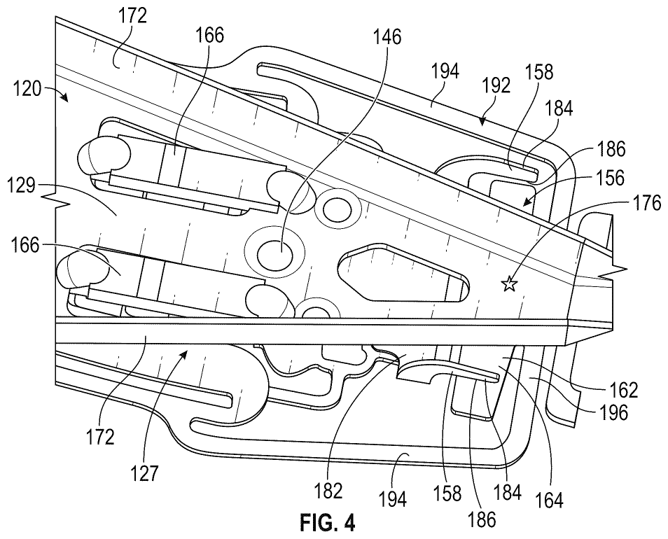

As shown in FIGS. 3-7, a limiter assembly 156 of the current disclosure is formed integrally with flexure 147. In an exemplary embodiment, limiter assembly 156 includes limiters 158 and a catch bar 162. In an exemplary embodiment, the limiter assembly 156 is symmetrical about the longitudinal line 168, with both limiters 158 extending distally and upwardly from tongue 182. In an exemplary embodiment, each of the limiters 158 is configured as a hook shaped arm or tab. Distal ends or tips 184 of the hook shaped limiters 158 bend over catch bar 162. During a shock event or other motion causing slider 102 to move downward and away from load beam 120, the bottom edges 186 of the tips 184 contact the top surface 164 of catch bar 162, thus limiting the distance of travel of slider 102 from slider dimple 146.

Because all components of limiter assembly 156 are formed integrally with flexure 147, manufacturing involves cutting and bending of the material of flexure 147, such as circuit steel for example, but does not require additional parts or attachment steps. These features preserve the low mass or weight of the head suspension and enhance manufacturing ease. Moreover, there are no extra parts or attachment structures such as adhesive or solder that can cause contamination by loosening or other degradation during disk drive operation.

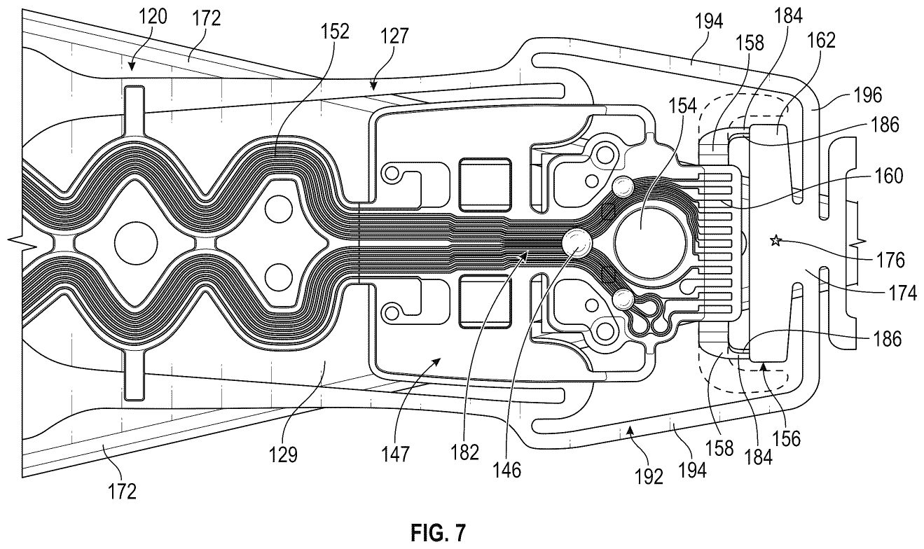

In an exemplary embodiment, the hook-shaped limiters 158 are located at the trailing (distal) side of the slider 102. Referring to FIG. 7, the phantom lines show the cut outlines of limiters 158 before they are bent upward and out of the plane of the slider mounting region 154 of the tongue 182. The hook-shaped limiters 158 are formed by bending upward on the circuit steel at the tongue 182. The hook-shaped limiters 158 engage a catch or cross bar 162 that extends proximally from the ring gimbal 127, away from the lift tab 128. In an exemplary embodiment, the catch cross bar 162 is formed integrally with the ring gimbal 127, also of circuit steel.

As shown in FIG. 5, slider dimple 146 protrudes from the rigid region 129 of load beam 120 toward slider 102. Slider dimple 146 is configured as a conical or hemi-spherical protrusion to provide a pivot point for movement of slider 102 and transfer the preload force from load beam 120 to slider 102. In the illustrated embodiment, the main mechanical support of slider 102 mounted to slider support region 154 comes from gimbal 127 and load beam 120, by way of contact at slider dimple 146. In such cases, slider dimple 146 provides a region of pivot motion of slider 102 in the pitch, roll, and yaw directions, and gimbal 127 provides structural support for slider 102 as it pivots about slider dimple 146.

As shown in FIG. 3, in an exemplary embodiment of HGA 116 of the current disclosure, centerline 168 is a longitudinal x-direction line dividing HGA 116 in halves. In some scenarios, HGA 116 is substantially symmetrical (the halves are mirror images) about centerline 168. In an exemplary embodiment, two proximal weld spots 176 that attach flexure 147 and load beam 120 are equidistantly spaced from centerline 168 in the Y direction and lie in the same X direction plane. In an exemplary embodiment, the two weld spots 176 are located on opposed sides of aperture 170.

As shown in FIGS. 6 and 7, in an exemplary embodiment, electrical trace ribbon 152 includes conductors that run alongside each side of flexure 147 to extend to a ring gimbal 127. Ring gimbal 127 includes a slider support region 154 configured to provide a surface for mounting slider 102 to flexure 147. In an exemplary embodiment, slider support region 154 may include one or more rigid pieces that may be made of metal, such as stainless steel, aluminum, or other metal. Slider support region 154 may include one or more flexible pieces, and, in some examples, layers of flexible and/or rigid pieces. In some examples, the pieces of slider support region 154 may be made of polymer, ceramic, or may be a layered laminate structure of metal, polymer, and/or ceramic materials. Slider 102 may be mounted to slider support region 154 using adhesive, epoxy, or other appropriate means of coupling an electrical component to a substrate.

In an exemplary embodiment, slider support region 154 includes bondpads 160 for electrically coupling electrical trace ribbon 152 to slider 102. An end of electrical trace ribbon 152 may terminate on slider support region 154 and may be electrically coupled to bondpads 160 via a conductive junction such as a solder contact.

In an exemplary embodiment, gimbal 127 is configured to provide motive support to slider 102 as slider 102 moves in proximity to a media surface 104. Gimbal 127 is sometimes referred to as a “ring gimbal” because of the generally annular shape conferred by struts or outriggers 194 joined to distal portion 196, for example. In one example, gimbal 127 is made of one or more metals (e.g., stainless steel), metal alloys, ceramic materials, polymeric materials, composite materials, or other structural materials. Gimbal 127 may be structurally designed to support the functional motion of slider 102 in the pitch, roll, and yaw directions while simultaneously reducing the amplitude of off-track movement of slider 102 in response to vibrations at resonance modes of HGA 116. Other descriptions relevant to a ring gimbal are described in commonly owned U.S. Pat. No. 10,957,350 for “Head Gimbal Assembly with Structural Yaw Stiffener,” and in commonly owned U.S. Pat. No. 11,289,120 for “Stress-Reducing Gimbal Tethers,” which are hereby incorporated by reference. In an exemplary embodiment, flexure 147 electrically connects the read and write heads of the slider 102, microactuators 166, and a plurality of bond pads 160 to an external control system. Flexure 147 can include any number of leads or traces. In this disclosure, the flexure 147 may sometimes be referred to as a circuit.

Referring to FIGS. 6 and 7, in an exemplary embodiment, catch cross bar 162 is connected to distal portion 196 by a narrowed neck 174. Because of this structural separation, forces transferred from the limiters 158 to the cross bar 162 are largely isolated from the ring 192. FIG. 7 shows in phantom lines the configuration of limiters 158 cut from the gimbal material before being bent upward at a substantially right angle. The limiters 158 and cross bar 162 have geometries that allow these parts to be cut from a flat sheet of the circuit material. The separation of cross bar 162 from distal portion 196 by neck 174 also allows for savings in materials and mass.

Referring to FIGS. 3-5, a z-direction position of cross bar 162 is fixed to a bottom surface of load beam 120 at a central weld point 176. Thus, deflection of the slider 102 attached to slider support region 154 of tongue 182 is limited by the vertical gap distance between a bottom edge 186 of the hook-shaped limiter 158 and the top surface 164 of the cross bar 162.

In an exemplary embodiment, each of the limiters 158 is located transversely outside of the rails 172 (in the y-direction). This wide lateral stance of the two limiters 158 provides lateral symmetry and stability in the z-direction limiting function. Moreover, placing the upward extending limiters 158 outside of the load beam rails 172 allows the limiters 158 to be positioned at the same vertical or z-height locations as the load beam, without interfering structurally with components carried by the load beam 120 (see FIGS. 2 and 5). Moreover, unlike other configurations where limiters are positioned under or over the load beam, the current disclosed limiter assembly 156 has a very low profile (in the z-direction).

Exemplary, non-limiting embodiments of a disk drive assembly and method are described. In one embodiment, a disk drive assembly comprises a load beam 120 having a longitudinal centerline 168 and a flexure 147 attached to the load beam 120. The flexure 147 comprises a deflectable tongue 182 and a ring 192. The deflectable tongue 182 comprises a pad 154 configured for mounting a slider 102 having a trailing edge. The ring 192 surrounds a trailing edge portion of the tongue 182 and comprises a catch 162. The tongue 182 comprises a plurality of limiters 158 that are disposed symmetrically about the longitudinal centerline 168, that are bent from a plane of the pad 154, and that extend away from the slider 102. The plurality of limiters 158 are configured to contact the catch 162 to limit deflection of the slider 102.

In an exemplary embodiment, the catch 162 is connected to a distal portion 196 of the ring 192 by a narrowed neck 174. In an exemplary embodiment, the catch 162 is fixed to the load beam 120 (such as by weld 176, for example). In an exemplary embodiment, the plurality of limiters 158 extend upward from the plane of the pad 154. In an exemplary embodiment, the load beam 120 has a pair of rails 172, and the plurality of limiters 158 are disposed transversely outside of the pair of rails 172. In an exemplary embodiment, the plurality of limiters 158 are disposed alongside the pair of rails 172 in a common horizontal, z-direction plane (as shown in FIGS. 2 and 5, for example). In an exemplary embodiment, each of the plurality of limiters 158 has a hook shape. In an exemplary embodiment, the load beam 120 comprises a dimple 146 in contact with the slider 102.

An exemplary method of limiting deflection of an air bearing slider 102 in a z-direction is described. The method comprises obtaining the air bearing slider 102 that is positioned on a longitudinal centerline 168 of a load beam 120, wherein the slider 102 is mounted to a pad 154 of a deflectable tongue 182 of a flexure 147 attached to the load beam 120, wherein the tongue 182 comprises a plurality of limiters 158 that extend upward and are positioned transversely outward of rails 172 of the load beam 120; and establishing physical contact between the plurality of limiters 158 and a catch 162 attached to a ring 192 of the flexure 147. In an exemplary embodiment, each of the plurality of limiters 158 is configured as a hook having a distally extending tip 184, and wherein establishing physical contact comprises a bottom edge 186 of the tip 184 touching a top surface 164 of the catch 162.

The illustrations of the embodiments described herein are intended to provide a general understanding of the structure of the various embodiments. The illustrations are not intended to serve as a complete description of all of the elements and features of apparatus and systems that utilize the structures or methods described herein. Features described with respect to any embodiment also apply to any other embodiment. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description. All patent documents mentioned in the description are incorporated by reference.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all modifications, enhancements, and other embodiments, which fall within the scope of the present disclosure. For example, features described with respect to one embodiment may be incorporated into other embodiments. Thus, to the maximum extent allowed by law, the scope of the present disclosure is to be determined by the broadest permissible interpretation of the following claims and their equivalents, and shall not be restricted or limited by the foregoing detailed description.

1. A disk drive head-gimbal assembly, comprising:
a load beam having a longitudinal centerline;
a flexure attached to the load beam and comprising:
a deflectable tongue comprising a pad configured for mounting a slider having a trailing edge; and
a ring surrounding a trailing edge portion of the tongue and comprising a catch;
wherein the tongue comprises a plurality of limiters that:
are disposed symmetrically about the longitudinal centerline;
are bent from a plane of the pad; and
extend away from the slider;
wherein the plurality of limiters are configured to contact the catch to limit deflection of the slider.

2. The assembly of claim 1, wherein the catch is connected to a distal portion of the ring by a narrowed neck.

3. The assembly of claim 1, wherein the catch is fixed to the load beam.

4. The assembly of claim 1, wherein the plurality of limiters extend upward from the plane of the pad.

5. The assembly of claim 1, wherein the load beam has a pair of rails, and wherein the plurality of limiters are disposed transversely outside of the pair of rails.

6. The assembly of claim 5, wherein the plurality of limiters are disposed alongside the pair of rails in a common horizontal, z-direction plane.

7. The assembly of claim 1, wherein each of the plurality of limiters has a hook shape.

8. The assembly of claim 1, wherein the load beam comprises a dimple in contact with the slider.

9. A method of limiting deflection of an air bearing slider in a z-direction, the method comprising:
obtaining the air bearing slider that is positioned on a longitudinal centerline of a load beam, wherein the load beam comprises rails, wherein the slider is mounted to a pad of a deflectable tongue of a flexure attached to the load beam, wherein the tongue comprises a plurality of limiters that extend upward and are positioned transversely outward of the rails of the load beam; and
establishing physical contact between the plurality of limiters and a catch attached to a ring of the flexure.

10. The method of claim 9, wherein each of the plurality of limiters is configured as a hook having a distally extending tip, and wherein establishing physical contact comprises a bottom edge of the tip touching a top surface of the catch.
